(19) United States
(12) Patent Application Publication
(10) Pub. No.: US 2022/0047993 A1
(43) Pub. Date: Feb. 17, 2022

(54) APPLICATIONS OF OCEAN WAVE ENERGY CONVERTORS

(71) Applicant: Oscilla Power, Inc., Seattle, WA (US)

(72) Inventors: Timothy R. Mundon, Seattle, WA (US); Balakrishnan Nair, Sandy, UT (US)

(21) Appl. No.: 17/403,836

(22) Filed: Aug. 16, 2021

Related U.S. Application Data
(60) Provisional application No. 63/065,605, filed on Aug. 14, 2020.

(51) Int. Cl. B01D 61/10; F03B 13/22; F03C 1/013; B01D 61/02; B01D 61/08; C02F 1/44

(52) U.S. Cl. CPC B01D 61/10; F03B 13/22; F03C 1/013; B01D 61/025; C02F 2103/08; C02F 1/441; B01D 2313/243; B01D 2313/365; B01D 61/08

(57) ABSTRACT

A system for production of desalinated water includes a wave energy convertor for conversion of mechanical energy from ocean waves into electricity and mechanical energy in the form of a salt-water stream. The system further includes a desalination unit coupled to the wave energy convertor. The system further includes an electrical connection from the wave energy convertor to the desalination unit, configured to supply the electricity to the desalination unit. The system further includes a conduit to supply the salt-water stream produced by the wave energy convertor to the desalination unit, wherein the desalination unit is configured to produce desalinated water.

### CROSS-REFERENCE TO RELATED APPLICATIONS

This application claims the benefit of U.S. Provisional Application No. 63/065,605, filed on May 14, 2020, which is incorporated by reference herein in its entirety.

### BACKGROUND

This disclosure relates generally to wave energy systems. More specifically, this disclosure relates to harnessing wave energy to power desalination units. Additionally, this disclosure relates to harnessing wave energy to power a chemical synthesis plant. Additionally, this disclosure relates to harnessing wave energy to power processes.

### SUMMARY

The subject matter of the present application has been developed in response to the present state of the art, and in particular, in response to the problems and disadvantages associated with conventional deposition that have not yet been fully solved by currently available techniques. Accordingly, the subject matter of the present application has been developed to provide embodiments of a system, an apparatus, and a method that overcome at least some of the shortcomings of prior art techniques.

Disclosed herein is a system for production of desalinated water. The system includes a wave energy convertor for conversion of mechanical energy from ocean waves into electricity and mechanical energy in the form of a salt-water stream. The system further includes a desalination unit coupled to the wave energy convertor. The system further includes an electrical connection from the wave energy convertor to the desalination unit, configured to supply the electricity to the desalination unit. The system further includes a conduit to supply the salt-water stream produced by the wave energy convertor to the desalination unit, wherein the desalination unit is configured to produce desalinated water.

The wave energy convertor is a point absorber.

The wave energy convertor is a multi-mode point absorber configured to move and capture energy in more than one mode of motion comprising heave, pitch, roll, and surge.

The desalination unit is configured to utilize reverse osmosis.

The system includes at least one piston, wherein the piston is configured to produce the salt-water stream.

The wave energy convertor is configured to produce heat, wherein the heat is configured to be transferred to the salt-water stream. motion and relative movement between a surface float and a reaction structure.

The salt-water stream is a high-pressure salt-water stream.

The salt-water stream is a low-pressure salt-water stream.

The desalination unit is coupled directly to the wave energy convertor.

Disclosed herein is a method. The method includes generating electricity and mechanical energy from a wave energy convertor, wherein the mechanical energy is in the form of a salt-water stream. The method includes supplying the electricity to a desalination unit to power the desalination unit. The method includes supplying the salt-water stream to the desalination unit, wherein the desalination unit is configured to produce desalinated water.

The wave energy convertor is a point absorber.

The wave energy convertor is a multi-mode point absorber configured to move and capture energy in more than one mode of motion comprising heave, pitch, roll, and surge.

The desalination unit is configured to utilize reverse osmosis.

The method further includes producing heat with the wave energy convertor, wherein the heat is configured to be transferred to the salt-water stream.

The desalination unit is coupled directly to the wave energy convertor.

Disclosed herein is a system for chemical production. The system includes a wave energy convertor for conversion of mechanical energy from ocean waves into electricity and mechanical energy in the form of at least one pressurized fluid. The system further includes a chemical synthesis plant coupled to the wave energy convertor. The system further includes an electrical connection from the wave energy convertor to the chemical synthesis plant, configured to supply the electricity to the chemical synthesis plant. The system further includes a conduit to supply the pressured fluid produced by the wave energy convertor to the chemical synthesis plant, wherein the chemical synthesis plant is configured to produce a chemical.

The wave energy convertor may be a point absorber. The wave energy convertor may be a multi-mode point absorber configured to move and capture energy in more than one mode of motion comprising heave, pitch, roll, and surge.

The desalination unit may be configured to utilize reverse osmosis. The means for producing the low-pressure stream includes at least one piston.

The chemical may be an ammonia. The chemical may be a fertilizer.

The chemical may be a hydrocarbon (through hydrogenation). The chemical may be a nitric acid. The chemical may be a methanol.

Other aspects and advantages of embodiments of the present invention will become apparent from the following detailed description, taken in conjunction with the accompanying drawings, illustrated by way of example of the principles of the invention.

### BRIEF DESCRIPTION OF THE DRAWINGS

In order that the advantages of the subject matter may be more readily understood, a more particular description of the subject matter briefly described above will be rendered by reference to specific embodiments that are illustrated in the appended drawings. Understanding that these drawings depict only typical embodiments of the subject matter and are not therefore to be considered to be limiting of its scope, the subject matter will be described and explained with additional specificity and detail through the use of the drawings, in which:

FIG. 1 depicts a schematic diagram of embodiments of a two-body system subject to surge and pitch motion of waves, according to one or more embodiments of the present disclosure;

FIG. 2 depicts a float and reaction structure, according to one or more embodiments of the present disclosure;

FIG. 3 depicts a float and reaction structure, according to one or more embodiments of the present disclosure;

FIG. 4 depicts a schematic diagram of a system, according to one or more embodiments of the present disclosure;

FIG. 5 depicts a schematic diagram of a system, according to one or more embodiments of the present disclosure;

FIG. 6 depicts a schematic flow chart of a method, according to one or more embodiments of the present disclosure;

FIG. 7 depicts motions of the surface float, according to one or more embodiments of the present disclosure;

Throughout the description, similar reference numbers may be used to identify similar elements.

### DETAILED DESCRIPTION

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present invention may be embodied in other specific forms without departing from its spirit or essential characteristics. The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment,” “an embodiment,” or similar language means that a particular feature, structure, or characteristic described in connection with the indicated embodiment is included in at least one embodiment of the present invention. Thus, the phrases “in one embodiment,” “in an embodiment,” and similar language throughout this specification may, but do not necessarily, all refer to the same embodiment.

Furthermore, the described features, advantages, and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment,” “an embodiment,” or similar language means that a particular feature, structure, or characteristic described in connection with the indicated embodiment is included in at least one embodiment of the present invention. Thus, the phrases “in one embodiment,” “in an embodiment,” and similar language throughout this specification may, but do not necessarily, all refer to the same embodiment.

There are a variety of ocean-based systems that can benefit from incorporation of built-in energy harvesting solutions to extend or expand at least one of the following, among others: performance capabilities, lifetime, range, communication capability, and/or remote operation/control capability. These include, but are not limited to desalination units, chemical synthesis plants, and units or plants that include operations such as compaction, densification, liquefaction, solidification, gasification, vaporization, evaporation, boiling, or disintegration.

Disclosed herein is a system for production of desalinated water. The system includes a wave energy convertor for conversion of mechanical energy from ocean waves into electricity and mechanical energy in the form of a salt-water stream. The system further includes a desalination unit coupled to the wave energy convertor. The system further includes an electrical connection from the wave energy convertor to the desalination unit, configured to supply the electricity to the desalination unit. The system further includes a conduit to supply the salt-water stream produced by the wave energy convertor to the desalination unit, wherein the desalination unit is configured to produce desalinated water. The preceding subject matter of this paragraph characterizes example 1 of the present disclosure.

The wave energy convertor is a point absorber. The preceding subject matter of this paragraph characterizes example 2 of the present disclosure, wherein example 2 also includes the subject matter according to example 1, above.

For point absorber architectures, the required relative displacement of the two bodies (seafloor and float, or reaction structure and float) is related closely to the wave height, not the device size. Thus, although the device may reduce in size, the power take-out (PTO) must still manage the same relative displacement.

The wave energy convertor is a multi-mode point absorber configured to move and capture energy in more than one mode of motion comprising heave, pitch, roll, and surge. The preceding subject matter of this paragraph characterizes example 3 of the present disclosure, wherein example 3 also includes the subject matter according to any one of examples 1-2, above.

Some embodiments of this invention may employ a system design with multiple modes of energy capture. Some embodiments of the new wave energy converter can be conceptualized as point absorbers with additional modes of motion allowing energy capture from waves in pitch and roll as well as heave. Some embodiments of the device may have a surface float 102 shaped to maximize or emphasize energy capture in the dominant wave direction, and designed to move in heave, pitch and roll, but with different natural periods for each of these motions. In some embodiments, the natural periods of at least two of these three motions will be distributed across the significant period range where the cumulative wave energy content for the target deployment location is concentrated, resulting in a highly efficient wide-band energy capture across the across the wave spectrum.

The desalination unit is configured to utilize reverse osmosis. The preceding subject matter of this paragraph characterizes example 4 of the present disclosure, wherein example 4 also includes the subject matter according to any one of examples 1-3, above.

Some embodiments of the invention utilize reverse osmosis. Although described herein with reverse osmosis, other embodiments may utilize common processes and systems for desalination known to those in the art.

The system includes at least one piston, wherein the piston is configured to produce the salt-water stream. The preceding subject matter of this paragraph characterizes example 5 of the present disclosure, wherein example 5 also includes the subject matter according to any one of examples 1-4, above. The piston may serve as part of a larger system or apparatus that is able to mechanically propel the salt water and/or pressurize the salt water.

The wave energy convertor is configured to produce heat, wherein the heat is configured to be transferred to the salt-water stream. The preceding subject matter of this paragraph characterizes example 6 of the present disclosure, wherein example 6 also includes the subject matter according to any one of examples 1-5, above. The wave energy convertor may be configured to produce heat from the wave motion and relative movement between a surface float and a reaction structure.

The salt-water stream is a high-pressure salt-water stream. The preceding subject matter of this paragraph characterizes example 7 of the present disclosure, wherein example 7 also includes the subject matter according to any one of examples 1-6, above. A high-pressure salt-water stream refers to a relative high pressure that is above atmospheric pressure or orders of magnitude above atmospheric pressure.

The salt-water stream is a low-pressure salt-water stream. The preceding subject matter of this paragraph characterizes example 8 of the present disclosure, wherein example 8 also includes the subject matter according to any one of examples 1-7, above. A low-pressure salt-water stream refers to a relative low pressure that is above atmospheric pressure and below an order of magnitude greater than atmospheric pressure.

The desalination unit is coupled directly to the wave energy convertor. The preceding subject matter of this paragraph characterizes example 9 of the present disclosure, wherein example 9 also includes the subject matter according to any one of examples 1-8, above. In some embodiments, the desalination unit may be coupled directly to the wave energy convertor. Other embodiments include a remote desalination unit that is still powered at least partially by the wave energy converter and can utilize the mechanical energy produced as well. In some embodiments, the desalination unit will be on top of the surface float of a wave energy convertor. In some embodiments, the desalination unit will be on a separate float coupled to and near the surface float of the wave energy convertor. In some embodiments, the electrical energy of the wave energy convertor is stored in a battery or other energy storage device and is later used to power the desalination unit.

Disclosed herein is a method. The method includes generating electricity and mechanical energy from a wave energy convertor, wherein the mechanical energy is in the form of a salt-water stream. The method includes supplying the electricity to a desalination unit to power the desalination unit. The method includes supplying the salt-water stream to the desalination unit, wherein the desalination unit is configured to produce desalinated water. The preceding subject matter of this paragraph characterizes example 10 of the present disclosure.

The wave energy convertor is a point absorber. The preceding subject matter of this paragraph characterizes example 11 of the present disclosure, wherein example 11 also includes the subject matter according to example 10, above.

The wave energy convertor is a multi-mode point absorber configured to move and capture energy in more than one mode of motion comprising heave, pitch, roll, and surge. The preceding subject matter of this paragraph characterizes example 12 of the present disclosure, wherein example 12 also includes the subject matter according to any one of examples 10-11, above.

The desalination unit is configured to utilize reverse osmosis. The preceding subject matter of this paragraph characterizes example 13 of the present disclosure, wherein example 13 also includes the subject matter according to any one of examples 10-12, above.

The method further includes producing heat with the wave energy convertor, wherein the heat is configured to be transferred to the salt-water stream. The preceding subject matter of this paragraph characterizes example 14 of the present disclosure, wherein example 14 also includes the subject matter according to any one of examples 10-13, above.

The desalination unit is coupled directly to the wave energy convertor. The preceding subject matter of this paragraph characterizes example 15 of the present disclosure, wherein example 15 also includes the subject matter according to any one of examples 10-14, above.

Disclosed herein is a system for production of desalinated water. The system includes a wave energy convertor for conversion of mechanical energy from ocean waves into electricity and to produce heat used to produce a higher temperature salt-water stream. The system further includes a desalination unit coupled to the wave energy convertor. The system further includes an electrical connection from the wave energy convertor to the desalination unit, configured to supply the electricity to the desalination unit. The system further includes a heat transfer device to supply the heat to the salt-water stream, wherein the desalination unit is configured to produce desalinated water. The preceding subject matter of this paragraph characterizes example 16 of the present disclosure.

The wave energy convertor is a point absorber. The preceding subject matter of this paragraph characterizes example 17 of the present disclosure, wherein example 17 also includes the subject matter according to example 16, above.

The wave energy convertor is a multi-mode point absorber configured to move and capture energy in more than one mode of motion comprising heave, pitch, roll, and surge. The preceding subject matter of this paragraph characterizes example 18 of the present disclosure, wherein example 18 also includes the subject matter according to any one of examples 16-17, above.

The desalination unit is configured to utilize reverse osmosis. The preceding subject matter of this paragraph characterizes example 19 of the present disclosure, wherein example 19 also includes the subject matter according to any one of examples 16-18, above.

Disclosed herein is a system for production of desalinated water. The system includes a wave energy convertor for conversion of mechanical energy from ocean waves into electricity and mechanical energy in the form of a low pressure fresh-water stream. The system further includes a desalination unit coupled to the wave energy convertor. The system further includes an electrical connection from the wave energy convertor to the desalination unit, configured to supply the electricity to the desalination unit. The system further includes a conduit to supply the low pressure fresh-water stream produced by the wave energy convertor to the desalination unit, wherein the desalination unit is configured to produce desalinated water. The preceding subject matter of this paragraph characterizes example 20 of the present disclosure.

The wave energy convertor is a point absorber. The preceding subject matter of this paragraph characterizes example 21 of the present disclosure, wherein example 21 also includes the subject matter according to example 20, above.

The wave energy convertor is a multi-mode point absorber configured to move and capture energy in more than one mode of motion comprising heave, pitch, roll, and surge. The preceding subject matter of this paragraph characterizes example 22 of the present disclosure, wherein example 22 also includes the subject matter according to any one of examples 20-21, above.

The desalination unit is configured to utilize reverse osmosis. The preceding subject matter of this paragraph characterizes example 23 of the present disclosure, wherein example 23 also includes the subject matter according to any one of examples 20-22, above.

The means for producing the low-pressure stream includes at least one piston. The preceding subject matter of this paragraph characterizes example 24 of the present disclosure, wherein example 24 also includes the subject matter according to any one of examples 20-23, above.

Disclosed herein is a system for chemical production. The system includes a wave energy convertor for conversion of mechanical energy from ocean waves into electricity and mechanical energy in the form of at least one pressurized fluid. The system further includes a chemical synthesis plant coupled to the wave energy convertor. The system further includes an electrical connection from the wave energy convertor to the chemical synthesis plant, configured to supply the electricity to the chemical synthesis plant. The system further includes a conduit to supply the pressured fluid produced by the wave energy convertor to the chemical synthesis plant, wherein the chemical synthesis plant is configured to produce a chemical. The preceding subject matter of this paragraph characterizes example 25 of the present disclosure.

The wave energy convertor is a point absorber. The preceding subject matter of this paragraph characterizes example 26 of the present disclosure, wherein example 26 also includes the subject matter according to example 25, above.

The wave energy convertor is a multi-mode point absorber configured to move and capture energy in more than one mode of motion comprising heave, pitch, roll, and surge. The preceding subject matter of this paragraph characterizes example 27 of the present disclosure, wherein example 27 also includes the subject matter according to any one of examples 25-26, above.

The desalination unit is configured to utilize reverse osmosis. The preceding subject matter of this paragraph characterizes example 28 of the present disclosure, wherein example 28 also includes the subject matter according to any one of examples 25-27, above.

The means for producing the low-pressure stream includes at least one piston. The preceding subject matter of this paragraph characterizes example 29 of the present disclosure, wherein example 29 also includes the subject matter according to any one of examples 25-28, above.

The chemical is an ammonia. The preceding subject matter of this paragraph characterizes example 30 of the present disclosure, wherein example 30 also includes the subject matter according to any one of examples 25-29, above.

The chemical is a fertilizer. The preceding subject matter of this paragraph characterizes example 31 of the present disclosure, wherein example 31 also includes the subject matter according to any one of examples 25-29, above.

The chemical is a hydrocarbon (through hydrogenation). The preceding subject matter of this paragraph characterizes example 32 of the present disclosure, wherein example 32 also includes the subject matter according to any one of examples 25-29, above.

The chemical is a nitric acid. The preceding subject matter of this paragraph characterizes example 33 of the present disclosure, wherein example 33 also includes the subject matter according to any one of examples 25-29, above.

The chemical is a methanol. The preceding subject matter of this paragraph characterizes example 34 of the present disclosure, wherein example 34 also includes the subject matter according to any one of examples 25-29, above.

Disclosed herein is a system for chemical production. The system includes a wave energy convertor for conversion of mechanical energy from ocean waves into electricity and/or thermal energy in the form of at least one high temperature fluid or solid. The system further includes a chemical synthesis plant coupled to the wave energy convertor. The system further includes an electrical connection from the wave energy convertor to the chemical synthesis plant, configured to supply the electricity to the chemical synthesis plant. The system further includes a conduit to supply the high temperature fluid or solid produced by the wave energy convertor to the chemical synthesis plant, wherein the chemical synthesis plant is configured to produce a chemical. The preceding subject matter of this paragraph characterizes example 35 of the present disclosure.

The wave energy convertor is a point absorber. The preceding subject matter of this paragraph characterizes example 36 of the present disclosure, wherein example 36 also includes the subject matter according to example 35, above.

The wave energy convertor is a multi-mode point absorber configured to move and capture energy in more than one mode of motion comprising heave, pitch, roll, and surge. The preceding subject matter of this paragraph characterizes example 37 of the present disclosure, wherein example 37 also includes the subject matter according to any one of examples 35-36, above.

The desalination unit is configured to utilize reverse osmosis. The preceding subject matter of this paragraph characterizes example 38 of the present disclosure, wherein example 38 also includes the subject matter according to any one of examples 35-37, above.

Disclosed herein is a system for chemical production. The system includes a wave energy convertor for conversion of mechanical energy from ocean waves into electricity and mechanical energy in the form of at least one low pressure fluid. The system further includes a chemical synthesis plant coupled to the wave energy convertor. The system further includes an electrical connection from the wave energy convertor to the chemical synthesis plant, configured to supply the electricity to the chemical synthesis plant. The system further includes a conduit to supply the low pressure fluid produced by the wave energy convertor to the chemical synthesis plant, wherein the chemical synthesis plant is configured to produce a chemical. The preceding subject matter of this paragraph characterizes example 39 of the present disclosure.

The wave energy convertor is a point absorber. The preceding subject matter of this paragraph characterizes example 40 of the present disclosure, wherein example 40 also includes the subject matter according to example 39, above.

The wave energy convertor is a multi-mode point absorber configured to move and capture energy in more than one mode of motion comprising heave, pitch, roll, and surge. The preceding subject matter of this paragraph characterizes example 41 of the present disclosure, wherein example 41 also includes the subject matter according to any one of examples 39-40, above.

The desalination unit is configured to utilize reverse osmosis. The preceding subject matter of this paragraph characterizes example 42 of the present disclosure, wherein example 42 also includes the subject matter according to any one of examples 39-41, above.

The means for producing the low-pressure stream includes at least one piston. The preceding subject matter of this paragraph characterizes example 43 of the present disclosure, wherein example 43 also includes the subject matter according to any one of examples 39-42, above.

Disclosed herein is a system for aiding in a process. The system includes a wave energy convertor for conversion of mechanical energy from ocean waves into electricity and mechanical energy in the form of at least high pressure fluid. The system further includes an electrical connection from the wave energy convertor to an apparatus, configured to supply the electricity to the apparatus. The system further includes a conduit to supply the high pressure fluid produced by the wave energy convertor to the apparatus to assist in an operation. The operation may include one of compaction, densification, liquefaction, and solidification. The operation is a part in the production of a useful product. The preceding subject matter of this paragraph characterizes example 44 of the present disclosure.

Disclosed herein is a system for aiding in a process. The system includes a wave energy convertor for conversion of mechanical energy from ocean waves into electricity and mechanical energy in the form of at least low pressure fluid. The system further includes an electrical connection from the wave energy convertor to an apparatus, configured to supply the electricity to the apparatus. The system further includes a conduit to supply the low pressure fluid produced by the wave energy convertor to the apparatus to assist in an operation. The operation may include one of gasification, vaporization, evaporation, boiling, and disintegration. The operation is a part in the production of a useful product. The preceding subject matter of this paragraph characterizes example 45 of the present disclosure.

Ocean wave energy is a major renewable energy resource available globally. Utility scale wave energy, which is more predictable and can be located closer to major demand centers than solar or wind energy, is a significant market opportunity whose dormancy is due primarily to the unavailability of reliable and economically viable energy conversion technologies.

The World Energy Council indicates that the potential global market for wave energy is worth about $1 trillion and that wave energy could supply 6.5% of the US energy requirement. This estimate was supported in a recently released DOE study, in which a detailed assessment of US wave energy resources showed that the total annual available wave energy along the continental outer shelf, including Alaska & Hawaii, is approximately 10% greater than electricity consumption in coastal states.

Based on this analysis by DOE, US wave energy resources are capable of supporting 8% of domestic energy consumption. When the practicality of extracting available resources, conversion efficiency and regional differences are taken into account, the DOE's estimates suggest that wave energy could contribute approximately 20% and 10% of west coast and east coast consumption respectively. Based on projections from industry experts, some estimations are that the US wave energy market could total 600 MW, or 10% of the global total, in coming years.

Many industrial and chemical processes require or can be improved by utilization of one or more of factors such electricity, high/low pressure or high temperature. Wave energy convertors can be used to generate one or more of those factors such electricity, high/low pressure or high temperature. Consequently, wave energy convertors can be used to improve the operating efficiency and/or economics of many industrial and chemical processes. This invention describes a method and apparatus for utilization of wave energy systems in industrial and chemical processes.

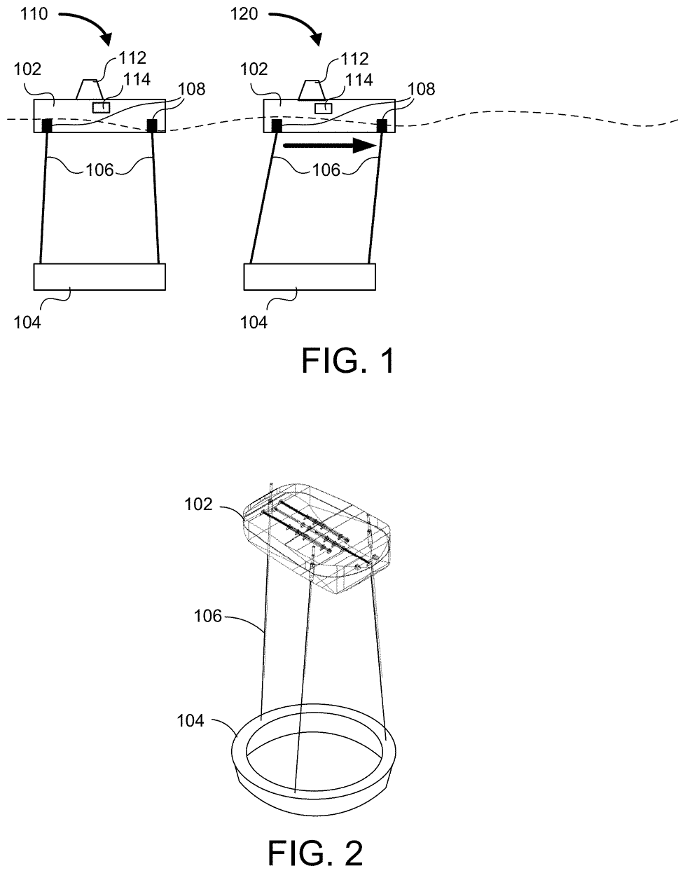

FIG. 1 depicts a schematic diagram of embodiments 110 and 120 of a two-body system subject to surge and pitch motion of waves. The illustrated embodiment 110 is an example of a two-body, flexibly-connected WEC, which may be subject to external forces of ocean waves. With the passage an impact of waves, the floating body (or surface float) 102 surges back and forth at the wave period as in the embodiment 120. In some embodiments, the reaction body (or reaction structure) 104, if one is used, is deployed far enough below the water surface that wave forces do not move it significantly and has a strong resistance to surge motion through its high inertia (structural mass and virtual mass) and/or high hydrodynamic drag (related to its vertical cross-sectional area). In the case of a sea-floor connected floating body, the sea-floor (or sea-floor mounted structure) would act as the reaction body, or equivalent, and effectively have infinite resistance to motion in the surge direction.

As the float body 102 surges horizontally with the waves, the reaction body moves very little or not at all in the horizontal direction. This motion of this system can be conceptually envisaged as a pendulum (or an inverted pendulum), where the pivot point is the reaction body or connection to the ocean floor. The natural period of a pendulum, Tn, is approximately given by the formula:

$${T}_{n} \approx 2 π \sqrt{\frac{L}{g}}$$

where L is the length of the pendulum tether, and g is the gravitational acceleration. The true natural period of a pendulum system may deviate slightly from this relation if the oscillation amplitude is large or if the moment of inertia and/or hydrodynamic properties of the floating body affect the dynamics.

While many embodiments may be implemented, two embodiments are described in detail herein. In one embodiment, the natural period of the inverted pendulum motion is tuned, through physical characteristics of the system components, to the period corresponding to the ocean waves of interest. This allows the WEC to be in resonance with the applicable wave motion and, therefore, absorbs the maximum amount of surge mechanical energy from the wave environment.

The illustrated embodiment also includes a power take off unit 108 for harnessing power from the wave energy converter. Coupled to the wave energy convertor is a desalination unit 112 and a conduit 114, both discussed in more detail herein.

Referring to FIG. 2, a float 102 and reaction structure 104 is depicted with three tendons 106 coupling them together. Such an apparatus is capable of harnessing tension as described herein.

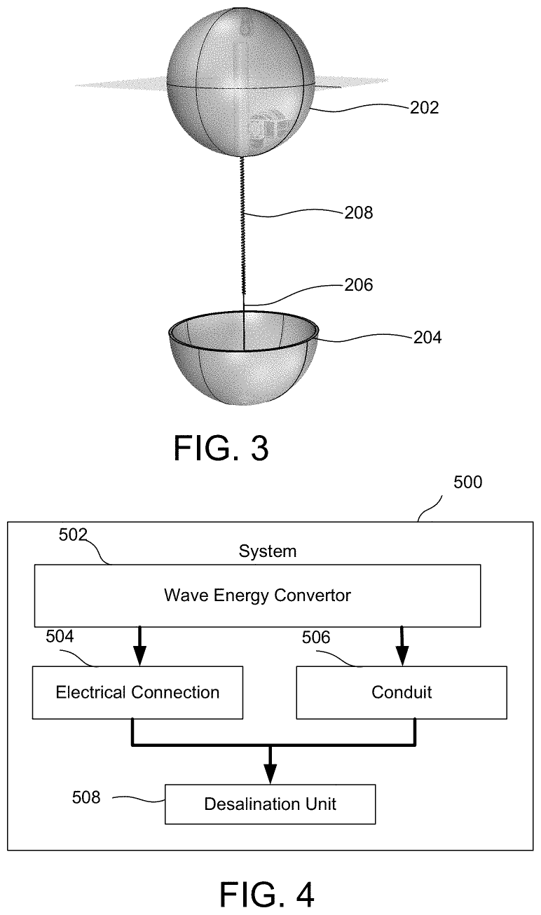

Referring to FIG. 3, a float 202 and reaction structure 204 is depicted with a single tendon 206 coupling them together including an extension spring 208. Such an apparatus is capable of harnessing tension and wave energy as described herein. The light weight of the reaction structure 204 relative to its area means that drag forces may become large relative to inertial forces and could mean that there will be a tendency for the tendons to experience snap loading. This can result in a risk of additional fatigue to the tendons 206. This can be mitigated in some embodiments by using variable geometry, such that the reaction structure 204 will fold inward on the downward travel, significantly reducing the drag area. This may be important in longer, larger waves where reaction forces are increasingly related to the reaction structure velocities. In smaller, shorter waves, reaction forces may be dominated by inertial forces, and in these cases the added mass terms may be relatively important.

In some embodiments, the UUV will have a somewhat limited buoyant restoring force when acting as a float, and especially when submerged, which will limit the power production. This can be improved by increasing the drag and added mass of the UUV body in heave by adding longitudinal features (fins) in the horizontal plane that will not impede normal streamwise flow when operating. This is not a requirement for the invention to function but can be used to improve the power performance.

As noted, the relative motion of the two bodies creates a useable force and displacement. This is converted into electrical energy through a compact power take-out (PTO). The choice of PTO in no way limits the scope of this invention and it is understood that the invention may be viable with many different types of PTO units. In some embodiments, the design of the PTO unit should be able to handle a long relative displacement between bodies to generate optimum power.

Referring now to FIG. 4, a schematic diagram of an embodiment of a system 500 for production of desalinated water is show. The system 500 includes a wave energy convertor 502 for conversion of mechanical energy from ocean waves into electricity and mechanical energy in the form of a salt-water stream. The system 500 further includes a desalination unit 508 coupled to the wave energy convertor 502. The system 500 further includes an electrical connection 504 from the wave energy convertor 502 to the desalination unit 508, configured to supply the electricity to the desalination unit 508. The system 500 further includes a conduit 506 to supply the salt-water stream produced by the wave energy convertor 502 to the desalination unit 508, wherein the desalination unit 508 is configured to produce desalinated water.

In some embodiments, the wave energy convertor is a point absorber. In some embodiments, the wave energy convertor is a multi-mode point absorber configured to move and capture energy in more than one mode of motion comprising heave, pitch, roll, and surge.

In some embodiments, the desalination unit is configured to utilize reverse osmosis. Although described herein with reverse osmosis, other embodiments may utilize common processes and systems for desalination known to those in the art.

In some embodiments, the system includes at least one piston, wherein the piston is configured to produce the salt-water stream.

In some embodiments, the wave energy convertor is configured to produce heat, wherein the heat is configured to be transferred to the salt-water stream. In some embodiments, the salt-water stream is a high-pressure salt-water stream. A high-pressure salt-water stream refers to a relative high pressure that is above atmospheric pressure or orders of magnitude above atmospheric pressure.

In some embodiments, the salt-water stream is a low-pressure salt-water stream. A low-pressure salt-water stream refers to a relative low pressure that is above atmospheric pressure and below an order of magnitude greater than atmospheric pressure.

In some embodiments, the desalination unit is coupled directly to the wave energy convertor. In some embodiments, the desalination unit may be coupled directly to the wave energy convertor. Other embodiments include a remote desalination unit that is still powered at least partially by the wave energy converter and can utilize the mechanical energy produced as well. In some embodiments, the desalination unit will be on top of the surface float of a wave energy convertor. In some embodiments, the desalination unit will be on a separate float coupled to and near the surface float of the wave energy convertor. In some embodiments, the electrical energy of the wave energy convertor is stored in a battery or other energy storage device and is later used to power the desalination unit.

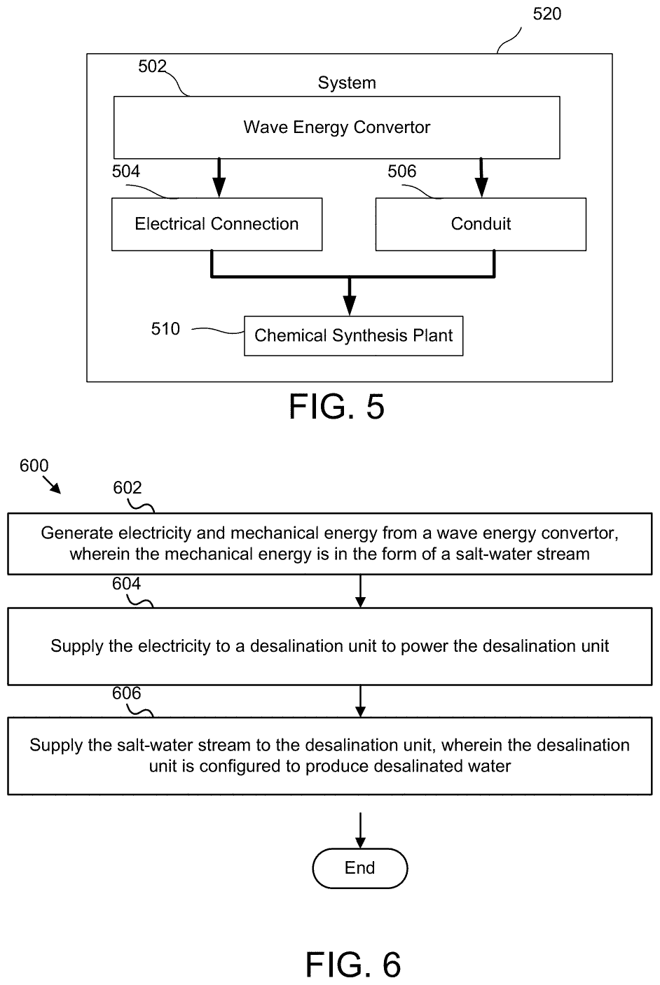

Referring now to FIG. 5, a schematic diagram of a system 520 for chemical production. The system 520 includes a wave energy convertor 502 for conversion of mechanical energy from ocean waves into electricity and mechanical energy in the form of at least one pressurized fluid. The system 520 further includes a chemical synthesis plant 510 coupled to the wave energy convertor 502. The system 520 further includes an electrical connection 504 from the wave energy convertor 502 to the chemical synthesis plant 510, configured to supply the electricity to the chemical synthesis plant 510. The system 520 further includes a conduit 506 to supply the pressured fluid produced by the wave energy convertor 502 to the chemical synthesis plant 510, wherein the chemical synthesis plant 510 is configured to produce a chemical.

In some embodiments, the wave energy convertor is a point absorber. In some embodiments, the wave energy convertor is a multi-mode point absorber configured to move and capture energy in more than one mode of motion comprising heave, pitch, roll, and surge.

In some embodiments, the desalination unit is configured to utilize reverse osmosis. In some embodiments, the means for producing the low-pressure stream includes at least one piston.

In some embodiments, the chemical is an ammonia. In some embodiments, the chemical is a fertilizer. In some embodiments, the chemical is a hydrocarbon (through hydrogenation). In some embodiments, the chemical is a nitric acid. In some embodiments, the chemical is a methanol.

Referring now to FIG. 6, a schematic flow chart diagram of a method 600 is shown. At block 602, the method 600 includes generating electricity and mechanical energy from a wave energy convertor, wherein the mechanical energy is in the form of a salt-water stream. At block 604, the method 600 includes supplying the electricity to a desalination unit to power the desalination unit. At block 606, the method 600 includes supplying the salt-water stream to the desalination unit, wherein the desalination unit is configured to produce desalinated water. The method 600 then ends.

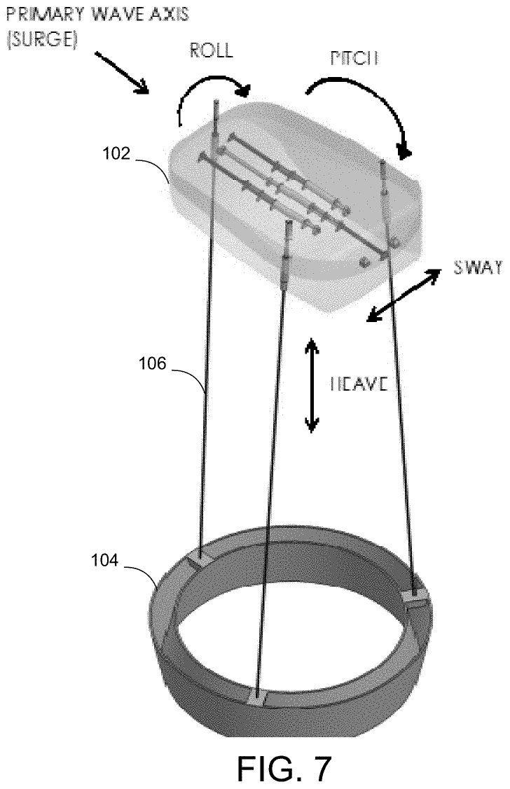

Embodiments of the invention relate to a multi-mode point absorber that captures energy in pitch, heave and roll, (see e.g., FIG. 7) and to methods of using and operating such a device. Some embodiments may comprise a surface float 102 that has dynamic characteristics that adjust or maximize motions in heave, pitch and roll at different natural frequencies that are distributed in order to improve (compared with static characteristics) or maximize energy capture across a wider range. When the surface float 102 interacts with the incident waves, the wave forces on the surface float 102 react against the heave plate 104 (which does not experience forces directly from the waves due to the depth at which it is deployed). This creates significant tension changes in the tethers 106, which are mechanically coupled to the linear powertrain 108 on the float. The nature of the flexible tethers 106 means that surface float motions in heave, pitch and roll (see e.g., FIG. 8) will result in tension changes. These applied forces on the linear powertrain 108 are the effective mechanical energy captured by the surface float 102 and provided as input to the linear hydraulic gearbox. A basic analytical approach provides that for a rated wave with a 10 s period, typical force and displacement inputs would be just under 2,000 kN with 2 m of stroke for a captured mechanical power of about 1.3 MW (electrical power output of about 1 MW). In some embodiments, the linear hydraulic gearbox converts this mechanical energy into a higher displacement, lower force mechanical energy, which is directly applied to linear generators with minimal energy loss (>95% efficiency). In some embodiments, the displacement amplification ratio may range from 0.5 to 100. In some embodiments, the displacement amplification ratio may range from 1.5 to 20, and more specifically from 2 to 8. In the system configuration shown, the linear hydraulic gearbox has a displacement amplification ratio of 4, enabling an 8 m linear generator stroke to be achieved internal to the surface float (500 kN/8 m per linear powertrain). The linear generator is able to convert this mechanical energy into electrical energy with very high efficiency (>85% typical). Some embodiments may employ methods for tuning the generator damping by employing machine configurations that allow for advanced control topologies whereby force and/or VAR support can be controlled for relatively high or maximum conversion efficiency. In some embodiments, the power electronics sub-system further conditions the output and converts it to a smooth, high-voltage DC output at high efficiency (>97% expected) to be delivered it to the grid through a High Voltage subsea transmission lines.

It should also be noted that at least some of the operations for the methods may be implemented using software instructions stored on a computer useable storage medium for execution by a computer. As an example, an embodiment of a computer program product includes a computer useable storage medium to store a computer readable program that, when executed on a computer, causes the computer to perform operations, including an operation to monitor a pointer movement in a web page. The web page displays one or more content feeds. In one embodiment, operations to report the pointer movement in response to the pointer movement comprising an interaction gesture are included in the computer program product. In a further embodiment, operations are included in the computer program product for tabulating a quantity of one or more types of interaction with one or more content feeds displayed by the web page.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

Embodiments of the invention can take the form of an entirely hardware embodiment, an entirely software embodiment, or an embodiment containing both hardware and software elements. In one embodiment, the invention is implemented in software, which includes but is not limited to firmware, resident software, microcode, etc.

Furthermore, embodiments of the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

Input/output or I/O devices (including but not limited to keyboards, displays, pointing devices, etc.) can be coupled to the system either directly or through intervening I/O controllers. Additionally, network adapters also may be coupled to the system to enable the data processing system to become coupled to other data processing systems or remote printers or storage devices through intervening private or public networks. Modems, cable modems, and Ethernet cards are just a few of the currently available types of network adapters.

Additionally, some or all of the functionality described herein might be implemented via one or more controllers, processors, or other computing devices. For example, a controller might be implemented to control the mooring lines, the tether(s) or tendon(s), or modes of the system.

In the above description, specific details of various embodiments are provided. However, some embodiments may be practiced with less than all of these specific details. In other instances, certain methods, procedures, components, structures, and/or functions are described in no more detail than to enable the various embodiments of the invention, for the sake of brevity and clarity.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

Although specific embodiments of the invention have been described and illustrated, the invention is not to be limited to the specific forms or arrangements of parts so described and illustrated. The scope of the invention is to be defined by the claims appended hereto and their equivalents.

What is claimed is:

1. A system for production of desalinated water comprising:
a wave energy convertor for conversion of mechanical energy from ocean waves into electricity and mechanical energy in the form of a salt-water stream;
a desalination unit;
an electrical connection from the wave energy convertor to the desalination unit, configured to supply the electricity to the desalination unit; and
a conduit to supply the salt-water stream produced by the wave energy convertor to the desalination unit, wherein the desalination unit is configured to produce desalinated water.

2. The system of claim 1, wherein the wave energy convertor is a point absorber.

3. The system of claim 1, wherein the wave energy convertor is a multi-mode point absorber configured to move and capture energy in more than one mode of motion comprising heave, pitch, roll, and surge.

4. The system of claim 1, wherein the desalination unit is configured to utilize reverse osmosis.

5. The system of claim 1, further comprising a piston, wherein the piston is configured to produce the salt-water stream.

6. The system of claim 1, wherein the wave energy convertor is configured to produce heat, wherein the heat is configured to be transferred to the salt-water stream.

7. The system of claim 1, wherein the salt-water stream is a high-pressure salt-water stream.

8. The system of claim 7, wherein the salt-water stream is a low-pressure salt-water stream.

9. The system of claim 1, wherein the desalination unit is coupled directly to the wave energy convertor.

10. A method comprising:
generating electricity and mechanical energy from a wave energy convertor, wherein the mechanical energy is in the form of a salt-water stream;
supplying the electricity to a desalination unit to power the desalination unit;
supplying the salt-water stream to the desalination unit, wherein the desalination unit is configured to produce desalinated water.

11. The method of claim 10, wherein the wave energy convertor is a multi-mode point absorber configured to move and capture energy in more than one mode of motion comprising heave, pitch, roll, and surge.

12. The method of claim 10, wherein the desalination unit is configured to utilize reverse osmosis.

13. The method of claim 10, further comprising producing heat with the wave energy convertor, wherein the heat is configured to be transferred to the salt-water stream.

14. The method of claim 10, wherein the desalination unit is coupled directly to the wave energy convertor.

15. A system for chemical production comprising:
a wave energy convertor for conversion of mechanical energy from ocean waves into electricity and mechanical energy in the form of at least one pressurized fluid;
a chemical synthesis plant;
an electrical connection from the wave energy convertor to the chemical synthesis plant, configured to supply the electricity to the chemical synthesis plant; and
a conduit to supply the at least one pressurized fluid produced by the wave energy convertor to the chemical synthesis plant, wherein the chemical synthesis plant is configured to produce a chemical.

16. The system of claim 15, wherein the chemical is at least one of an ammonia, a fertilizer, a hydrocarbon (through hydrogenation), a nitric acid, or a methanol.

17. The system of claim 15, wherein the wave energy convertor is a point absorber.

18. The system of claim 15, wherein the wave energy convertor is a multi-mode point absorber configured to move and capture energy in more than one mode of motion comprising heave, pitch, roll, and surge.

19. The system of claim 15, wherein the chemical synthesis plant is configured to utilize reverse osmosis.

20. The system of claim 15, wherein the chemical synthesis plant is coupled directly to the wave energy convertor.
